(19) United States
(12) Patent Application Publication
(10) Pub. No.: US 2001/0042029 A1
(43) Pub. Date: Nov. 15, 2001

(54) Own-likeness virtual model

(76) Inventor: Julian M. Galvez, Buenos Aires (AR)

Correspondence Address: Charles Fallow, Esq., Shoemaker and Mattare, Ltd., 2001 Jefferson Davis Highway, Arlington, VA, 22202, US

(21) Appl. No.: 09/774,886

(22) Filed: Feb. 1, 2001

Related U.S. Application Data
(60) Provisional application No. 60/179,483, filed on Feb. 1, 2000.

(51) Int. Cl. G06F 17/60

(52) U.S. Cl. 705/27

(57) ABSTRACT

Internet shoppers may view clothing applied to virtual models of themselves. An image of a computer user is stored, as are images of clothing articles. Selected clothing images are superimposed on the user's image so that he or she can observe the clothing in conjunction with his or her appearance.

This application claims benefit of the Feb. 1, 2000 filing date of provisional patent application 60/179483.

### BACKGROUND OF THE INVENTION

This invention relates to an own-likeness virtual model to be implemented on the Internet.

So-called e-commerce is by now well established and growing rapidly. One can buy services and merchandise over the Internet from one's personal computer by viewing items, making selections, and paying for the items selected with a credit card.

While books, music, hardware and software can be bought on the basis of information describing them, some classes of goods are best selected—at least in part—on the basis of their appearance as applied to their purchaser. Clothing, for example, must be tried on for a proper evaluation. What looks good on one person may not be attractive on another, owing to variations in the coloring, size and shape of people, and other factors, including the taste of the wearer. Cars, shoes, jewelry, makeup and certain other goods might also be judged best in conjunction with the person. Similarly, hair styles are matters which are best judged in association with the appearance of the person who will wear them.

It would be good, then, to permit prospective purchasers to “try on” items and services before purchasing them from remote locations over a network such as the Internet.

### SUMMARY OF THE INVENTION

An object of the invention is to allow a person shopping on the Internet to try on virtual services and articles of merchandise, prior to purchasing them.

These and other objects are attained by an own-likeness virtual model to which clothing and other articles of clothing may apparently be applied, so that one can see the effect of the articles in association with the person modeled.

### BRIEF DESCRIPTION OF THE DRAWINGS

In the accompanying drawings,

FIG. 1 is a simple diagram of a network such as the Internet, and

FIG. 2 is a representation of an own-likeness virtual model embodying the invention, fitted with a virtual shirt.

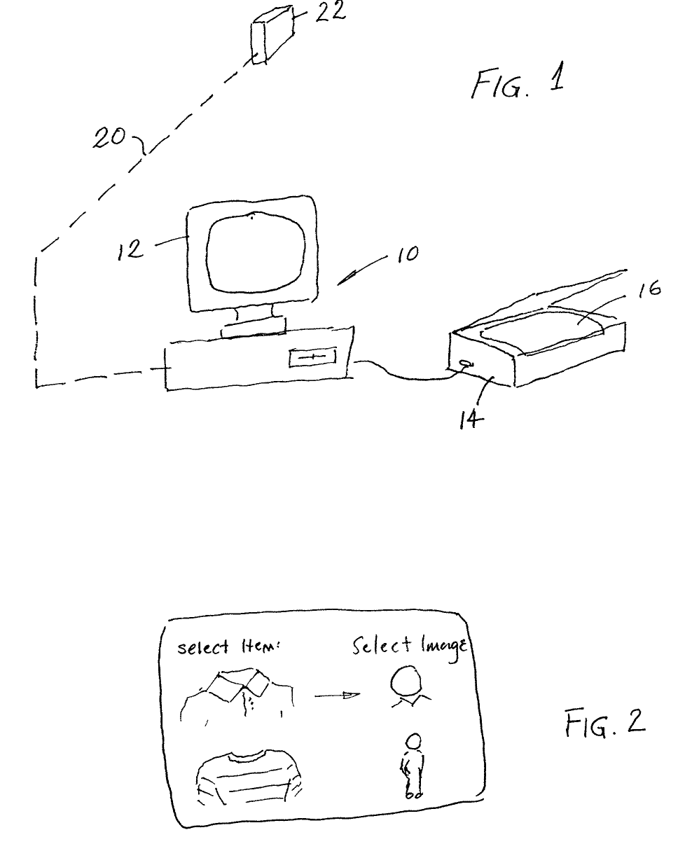

### DESCRIPTION OF THE PREFERRED EMBODIMENT

An own-likeness virtual model embodying the invention is implemented on a data communications system comprising a personal computer 10 having a display device (monitor) 12 and means such as a scanner 14 for ingesting an image such as a photograph 16 of the computer user.

The user's computer is connected to a network 20 such as the Internet, as is at least one other computer 22 accessible by the user's computer. The remote computer 22 may be a server at a producer's site. (The term “producer” is meant to include manufacturers, resellers, and providers of services.) The server contains information on goods or services for sale. The user's work station is used to store or transmit a digital image of the user. The type of image (full figure, bust, face, etc.) will depend on the good being “tried on”, and more than one image of the user may be maintained.

As an example, a clothing manufacturer may market a line of shirts over the Internet. The user may view assorted shirts in a conventional display (e.g., neatly folded). But also, according to this invention and exemplified in FIG. 2, the user may, on command, view a selected item applied to his own likeness. Thus, in this example he may virtually try on one, then another, of the shirts, by associating them with his image, something in the manner of dressing a paper doll. The exact implementation is a matter of ordinary programming skill. For example, one might click directly on a shirt to apply it to one's likeness, or one might pick the item from a list. One could similarly select between multiple likenesses of oneself, if more than one likeness had been generated. And suitable controls could permit the user to move (i.e., translate or rotate) the selected item and/or the selected image. In certain applications, it would also be advantageous to be able to zoom the selected item or the image, for example to check the appearance of different sizes of the same item.

The image(s) of the user may be uploaded to the producer's site, in which case the association or dressing of the image is done by the manufacturer's computer, and relayed back to the user's computer over the Internet. Alternatively, the user's computer could do the processing (virtual “dressing”), combining downloaded clothing images with the user's likeness image, in which case the likeness image could be stored locally. This latter approach would have advantages of better privacy and speed, but would require special software at the user's end, and perhaps greater physical system requirements such as memory.

While scanned photographs are contemplated presently as being the most suitable source of own-likeness images, it is within the scope of this invention to employ three-dimensional representations of the user. If images of the goods were also made available in a compatible three-dimensional format, one could view the articles, applied to his virtual form, from all angles, as if turning before a mirror.

The system could be made more sophisticated as desired. For example, the illusion could be given that one was selecting garments from a quantity on a store floor, and then walking to a dressing room to try on a selected garment. Upon purchase, another scene could invoke the impression of checking out at a cash register. Variations along these lines will occur to those of skill in the art.

I further contemplate that this invention will be applicable to post-purchase services.

It is expected that telecommunications technologies will continue to develop at a rapid rate. I expect that technologies not yet developed or even imagined may become common-place during the period of this patent, and intend that my claims shall be construed to cover all implementations of this invention on such new technologies.

Since the invention is subject to modifications and variations, it is intended that the foregoing description and the accompanying drawings shall be interpreted as only illustrative of the invention.

I claim:

1. An own-likeness virtual model to which clothing and other articles of clothing may apparently be applied, so that one can see the effect of the articles in association with the person modeled.

2. A method of allowing internet shoppers to virtually try on clothing, said method comprising steps of storing an image of a computer user, storing images of clothing articles, retrieving said image of said user and selected images of clothing articles, and superposing said images of clothing articles on said selected images of clothing articles.
